(19) United States
(12) Patent Application Publication
(10) Pub. No.: US 2004/0153635 A1
(43) Pub. Date: Aug. 5, 2004

(54) Privileged-based qualification of branch trace store data

(76) Inventors: Shivnandan D. Kaushik, Portland, OR (US); Bryant Bigbee, Scottsdale, AZ (US); Chris Newburn, Rockton, IL (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/334,695

(22) Filed: Dec. 30, 2002

(51) Int. Cl. H04B 1/74

(52) U.S. Cl. 712/236

(57) ABSTRACT

Methods and systems are provided to selectively log branch trace store data associated with the execution of an application. A privilege level is received, which identifies an execution mode for a processor for which branch trace store data is to be logged to a buffer. The privilege level is used to set one or more privilege flags that permit selective branch trace store data to be logged in the buffer when the application is executed. In one embodiment, the privilege level represents a user application mode, a supervisory application mode, or a mode representing both a user application mode and a supervisory application mode.

### TECHNICAL FIELD

Embodiments of the present invention relate generally to logging branch trace store data during execution of an application and more specifically to selectively permitting branch trace store data to be logged based on the privilege level at which the execution is occurring.

### BACKGROUND INFORMATION

Branch trace store data consists of information for branch instructions that are processed during the execution of a software application. The information stored represents origination and destination memory locations for each processed branch instruction. The data may also include branch prediction information associated with predicted branches that the processor calculates during execution of the particular instruction. The data is logged to a buffer during the application's execution.

Accordingly, if the software application encounters a failure or an unexpected result, then a debugger application can be used to trace the execution of instructions in order to determine what went wrong. Presently, the features associated with trapping and logging branch trace store data is controlled at the processor level of a machine, since the data includes a variety of architectural information available primarily to the processor.

Conventionally, branch trace store data that is logged to a memory buffer for an application will include branch data from both a user execution mode and a supervisory/kernel mode of a processor. As a result, the buffer cannot be directly made available to the user debugger application. Specifically, user mode applications such as debuggers should not have visibility to the branch trace store data for supervisory mode instructions executed in kernel/supervisory mode. This restriction is done for a variety of reasons, such as security concerns since it is not desirable to expose a user mode operator to supervisory data when a user application typically possesses a plurality of both user mode execution statements and supervisory mode execution statements (e.g., kernel instructions processed during execution by the OS on behalf of the user application). This is typically the case for multi-tasking Operating Systems (OS) where the OS performs services on behalf of the user mode application.

Furthermore, branch trace store data cannot be easily made available to a user mode operator due to efficiency reasons associated with machine architectures. This is so, because the OS would need to separately log supervisory and user mode data, which would require the multi-tasking/multi-threaded OS to maintain separate buffers for user and kernel mode data with every thread/task that logs the data and switches between the two buffers. Alternatively, any data supplied to a user would have to be inspected by the OS so that any supervisory data could be stripped before it is supplied to the user mode operator though a debugger.

Existing techniques would also require that a duplicate buffer be maintained in a user space to house the branch trace store data in order to exclude the stripped supervisory data from a user mode operator. This wastes memory and is considerably taxing on the resources of the machine. Branch trace store data is voluminous and maintaining dual buffers in memory is not desirable. As one of ordinary skill in the art appreciates, it is far more efficient and secure with conventional techniques to exclude user mode operators from access to branch trace store data, and this has been the case with conventional machine architectures.

Therefore, there is a need for improved implementations of techniques for logging branch trace store data. These implementations should permit more flexibility to user mode operators, such that branch trace store data can be made available and done so in an efficient way that is compatible with existing architectures. The implementations and techniques should also not unduly tax resources (e.g., processor and memory).

### BRIEF DESCRIPTION OF THE DRAWINGS

FIG. 1 is a flow diagram of a method to selectively log branch trace store data, in accordance with one embodiment of the invention.

FIG. 2 is a flow diagram of another method to selectively log branch trace store data, in accordance with one embodiment of the invention.

FIG. 3 is a diagram of a branch trace store data system, in accordance with one embodiment of the invention.

FIG. 4 is a diagram of an example data structure for selectively identifying branch trace store data, in accordance with one embodiment of the invention.

### DESCRIPTION OF THE EMBODIMENTS

Novel methods and systems for selectively logging branch trace store data are presented. In the following detailed description of the embodiments, reference is made to the accompanying drawings, which form a part hereof, and in which is shown by way of illustration, but not limitation, specific embodiments of the invention that may be practiced. These embodiments are described in sufficient detail to enable one of ordinary skill in the art to understand and implement them, and it is to be understood that other embodiments may be utilized and that structural, logical, and electrical changes may be made without departing from the spirit and scope of the present disclosure. The following detailed description is, therefore, not to be taken in a limiting sense, and the scope of the embodiments of the inventions disclosed herein is defined only by the appended claims.

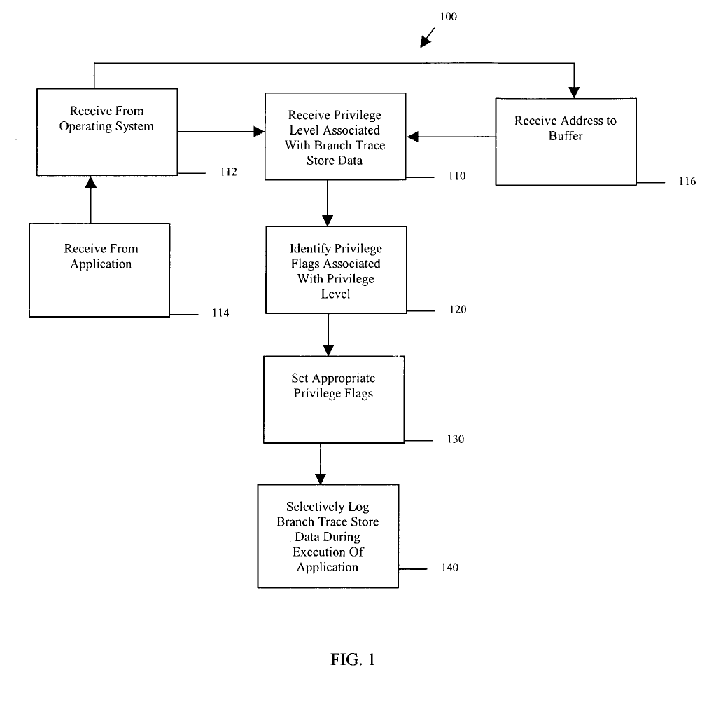

FIG. 1 illustrates a flow diagram of a method 100 to selectively log branch trace store data, in accordance with one embodiment of the invention. The method 100 is implemented in an electronic environment using firmware and/or software associated with one or more processors of a machine. The processors support an OS and a plurality of user applications. Memory and storage are also available to the processor and the machine. The OS and user environments can be logically organized and layered, such the OS layer is referred to as layer 0 and the user layer is referred to as layer 3. Additionally, other applications can make up a first layer and second layer, such as networking applications, protocol applications, device driver applications, and the like.

At 110, a privilege level is received by firmware and/or software associated with a processor hosting an OS and one or more user applications. The privilege level identifies an execution mode of the processor, such as a supervisory mode, a user mode, and others. The privilege level can be a numeric value that identifies a particular execution mode or a combination of execution modes. Of course, any electronic data type or data structure can be used to uniquely identify the privilege level.

In one embodiment, at 112, the privilege level for a defined user application is received by the processor's firmware and/or software from the OS via a system operation call made by the OS. The OS issues this operation in response to receiving a request and the privilege level from the user application, as depicted at 114. Moreover, in some embodiments, a memory buffer to which branch trace store data is to be logged is initially allocated and identified by the OS in response to an initial request from the user application. In turn, the processor's firmware and/or software receive an address or pointer to the allocated buffer from the OS at 116. The OS can use another system operation call to the processor in order to achieve this.

Once the processor's firmware and or software has received an identification of a user application, a privilege level, and an address or pointer to a buffer, affected privilege flags associated with the privilege level are identified at 120. The privilege flags are used by the processor's firmware and/or software to identify when the processor should write branch trace store data to the buffer identified by the received buffer address during the actual execution of branch instructions in the identified user application. Accordingly, at 130, the processor's firmware and/or software sets the affected privilege flags in order to selectively identify the types of branch trace store data that is to be logged to the buffer. These privilege flag settings are inspected during execution of the identified user application with each instruction processed, and if the flags indicate branch trace store data is to be logged to the buffer, then the processor's firmware and/or software takes this action.

In some embodiments, the privilege flags are represented as bit values for a word of the processor housed within a register of the processor while the identified user application executes. Moreover, the received privilege level can actually cause the processor to set more than one privilege flag. For example, a privilege level that desires both user mode and supervisory mode logging, can cause a privilege flag (e.g., bit field value) be set for user mode logging and a separate privilege flag be set for supervisory mode logging. Furthermore, in some instance, a previous setting may indicate that both user mode and supervisory mode are to be logged, but the received privilege level desires only user mode logging. In this instance, the processor will need to unset the supervisory mode's privilege flag to achieve the desired logging.

In another embodiment, in order to maintain backward compatibility with previous architectures of the processor, where both a user mode privilege field and supervisory mode privilege field were previously unused, reserved, and unset fields, a default situation can be employed where when both fields are unset logging occurs for both the user mode and the supervisory mode. This can be achieved since other bit fields will identify whether branch trace store data logging is to occur at all. Thus, if these other fields are set with the user mode and supervisory mode fields unset, logging occurs for both user mode and supervisory mode. If no logging is desired, then the one or more additional fields associated with activating logging will be unset, and thus no logging occurs. Therefore, conventional architectures will still operate as they currently do when the features of various embodiments of the present invention are made available.

As one of ordinary skill in the art appreciates, this provides tremendous flexibility since existing processor architectures do not need to be altered to be compatible with the present invention, since additional fields that were previously reserved can now be used for purposes of various embodiments described with this disclosure in an expected manner.

At 140, when the identified application begins execution, the processor's firmware and/or software will inspect the values of the privilege flags and determine whether any particular instruction is to be logged to the buffer. Thus, a single buffer is used to selectively log branch trace store data without exposing a user mode operator to supervisory mode data when it is not desirable to do so. Moreover, the OS does not have to scan the buffer to remove supervisory mode data, and a user debugger application can provide the benefits of inspecting and analyzing the buffer to user mode operators, which has not been available in the past.

In some embodiments, the OS is also capable of communicating (e.g., via system operation calls) various configuration aspects of the buffer to the processor. For example, the OS can inform the processor through a system call that the buffer is to be a circular buffer, such that branch trace store data is serially written to the buffer. When the buffer becomes full, new branch trace store data is written over the oldest branch trace store data occurring at beginning locations of the buffer. In still other embodiments, the buffer can be identified, such that when it becomes full the processor raises a flag or an interrupt to the OS, and the OS flushes the buffer to storage. In fact, any other configurable aspects of the buffer that is desirable can be achieved using a similar technique.

Various embodiments of the present invention are particularly well suited for processor architectures, such as, but not limited to, Instruction Set Architectures (ISAs) of Intel's Pentium 4 referred to as IA-32. Moreover, the embodiments of the present invention can be used in any Model Specific Register (MSR) architecture. Additionally, although various examples presented above discuss the selectively logging of user mode or supervisory mode for branch trace store data, the present invention is not intended to be so limited, since any processor execution mode can be used for selective or qualified logging. In fact, the teachings of various embodiments of the present invention can also be used to selectively log a variety of other information that may not normally be available to user mode operators, such as, but not limited to, machine states, performance monitoring data, event count data, performance data, and others.

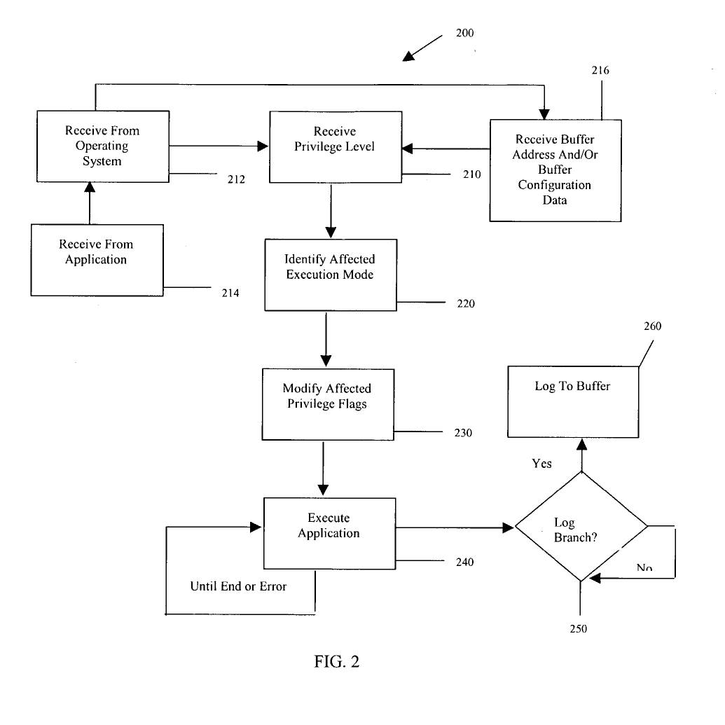

FIG. 2 illustrates a flow diagram of another method 200 to selectively log branch trace store data, in accordance with one embodiment of the invention. The method 200 is an article having a machine accessible medium that has instructions to implement the method 200. The instructions of the article are capable of performing method 200. In one embodiment, these instructions are embedded in the firmware and/or software accessible to one or more processors of the machine. The machine also includes memory and access to storage.

At 210, the instructions receive a privilege level from an OS, at 212. The OS receives the privilege level from a user application at 214. The privilege level identifies to the instructions one or more processor execution modes where branch trace store data is to be selectively logged. Moreover, the instructions can receive an address to a buffer that is used for logging the branch trace store data at 210. In still further embodiments, at 216, the instructions can process any received buffer configuration data from the OS.

In one embodiment, the OS provides the privilege level, the address to the buffer, and any buffer configuration data via system calls that activate the instructions. The OS can also independently allocate memory and determine the size of the buffer. Although, in some embodiments, the instructions can use predefined memory locations for the buffer. In these embodiments, the OS need not provide the address to the buffer or any buffer configuration data. Moreover, in these embodiments, the OS can use a system call to acquire the address of the buffer from the instructions when an application requests access to the branch trace store data. Alternatively, in these embodiments, the OS can be initially configured to be capable of resolving and acquiring the predefined address to the buffer.

Buffer configuration data can include information that identifies the type of buffer or attributes of the buffer. For example, the buffer may be circular such that when it becomes full the oldest data in the buffer is over written with the newest data being written to the buffer. Alternatively, the system can be configured to inform the instructions to raise a flag when it becomes full, such that the OS can flush the buffer contents to storage. Other buffer configuration data can include a header that identifies an offset within the beginning of the buffer where branch trace store data begins. The header information can also include date information, application information, and other types of information.

At 220, the privilege level received by the instructions is inspected to determine the affected execution modes of the processor where selective logging of branch trace store data is desired. In one embodiment, this causes the instructions to access a register where tracing control information is housed. The instructions then modify the appropriate privilege flags/fields and their corresponding values in order to activate the desired privilege level at 230. In some embodiments, the privilege flags/fields are bit fields associated with a word that is located in a register of a processor for the machine. Yet, one of ordinary skill in the art appreciates that the privilege flags/fields can be located in any memory or storage (volatile or non volatile) that is accessible to the instructions.

Once the instructions have set the appropriate privilege flags/fields that were affected by the received privilege level, an application can execute such that during execution branch trace store data associated with application instructions being processed are selectively written to the buffer. Accordingly, at 240, the application is executed until it exits normally or experiences a failure. Each application instruction that is executed for the application is then inspected at 250 to determine if the executed instruction corresponds to an execution mode that requires logging branch trace store data to the buffer. If the executed instruction does not correspond to an execution mode that has an associated privilege flag/field set for logging, then no action is taken (e.g., nothing is written to the buffer).

However, if at 250, an executed instruction for the application corresponds to an execution mode associated with a set privilege flag/field then at 260, the corresponding branch trace store data is logged to the buffer. As previously discussed, how branch trace store data is written to the buffer is dependent upon the type of buffer being used. Thus, if the buffer is a circular buffer, then data is serially written to the buffer and when the end of the buffer is reached data is written at the beginning at the buffer, this continues in a circular fashion. If the buffer is a type that is flushed to storage when it becomes full, then an interrupt of flag is raised to the OS, causing the OS to flush the buffer to storage.

It is now readily apparent to one of ordinary skill in the art how a machine can be implemented with instructions that are capable of selectively logging branch trace store data for an application based on a configurable privilege level that corresponds to an execution mode recognized by the machine. This is achieved without producing duplicate buffers within a user's environment and within an OS environment, and this provides user applications with access to branch trace store data. Thus, user mode operators can now use debuggers to trace the execution of an application when a failure or an unexpected result occurs. Alternatively, the branch trace store data can be used to trace application for purposes of improving the processing or memory performances.

Access to branch store trace data is particularly useful to software developers that design and implement user applications. Conventionally, for reasons of security and efficiency the branch trace store data was not made available to user mode developers. In some instances, this had made the debugging process more difficult and time consuming for developers. Moreover, as discussed above with respect to FIG. 1, various embodiments of the present invention can be deployed with existing machine architectures. Thus, in various embodiments of the present invention, the teachings can be used in a backwardly compatible fashion.

Further, the processor of the machine with various embodiments of the present invention can include any type of processor capable of executing firmware and/or software, such as a microprocessor, digital signal processor, microcontroller, or the like. The processor can include microcode, macrocode, software, programmable logic or hard coded logic for performing the execution of instructions of the machine.

Memory used by the machine in various embodiments of the present invention can be a processor register, a hard disk, a floppy disk, random access memory (RAM), read only memory (ROM), flash memory, any other type of machine medium readable by a processor, or any combination of the above devices. Memory can store instructions and/or data for performing the execution of the instructions of the machine.

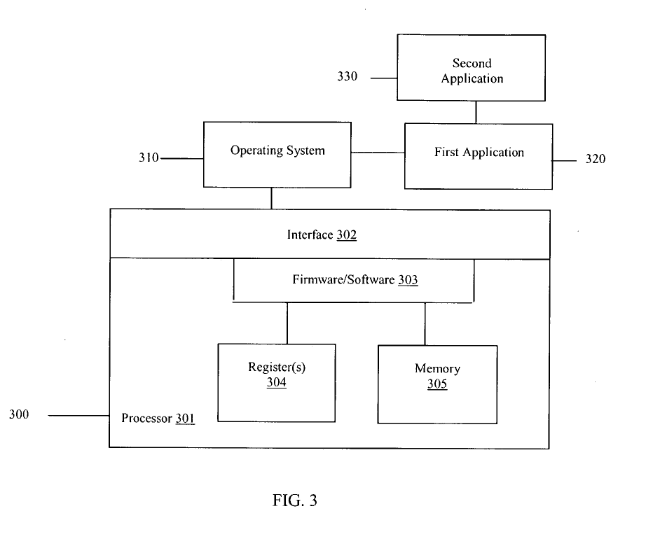

FIG. 3 illustrates a diagram of one branch trace store data system 300, in accordance with one embodiment of the invention. The branch trace store data system 300 includes a processor 301 and an interface 302. The processor includes firmware and/or software 303, one or more registers 304, and memory 305. The branch trace store data system 300 can also be embodied in any computing device or machine where multiple instances of a processor 301 are deployed. The branch trace store data system 300 can also have access to non-volatile storage and/or memory in addition to volatile storage and/or memory.

The interface 302 includes one or more operations recognized by the firmware and/or software 303 that permit the firmware and/or software 303 to selectively define and log branch trace store data. Thus, the interface 302 permits system calls/operations from an OS 310 that identify a privilege level associated with an execution mode (e.g., user mode, supervisory mode, and others) of the processor 301. The OS 310 generates the system calls in response to a request received from a first user application 320 (e.g., user debugger and the like). In this way, the first application 320 indirectly provides a desired privilege level through the interface 302 of the processor 301 via the OS 310.

The first application 320 also identifies a second application 330 that is associated with the privilege level. The identity of the second application 330 is also communicated through the OS 310 and then on to the interface 302. The firmware and/or software 303 of the processor 301 react to the system calls initiated by the OS 310 through the interface 302 in order to set privilege flags/fields that are associated with the received privilege level. In some embodiments, the OS 310 also reserves or allocates a portion of the memory 305 as space for branch trace store data to be logged. In these embodiments, the OS 310 also uses the interfaces to provide the processor 301 with the address of the buffer in memory 305.

Further, in some embodiments, the OS 310 uses the interface 302 to provide other configuration data associated with the buffer in memory 305. For example, the buffer can be a circular buffer or a buffer that is flushed to storage when it becomes full. Also, header information can be provided as configuration data such that any offset associated with the beginning of the memory 305 location can be identified and resolved where branch trace store data is to begin within the buffer.

Once the OS 310 has accessed the interface 302 in order to provide the identity of the second application 330, the desired privilege level requested by the first application 320, and any buffer information, the firmware and/or software 303 of the processor 301 inspects the provided privilege level to determine what register 304 to access. The appropriate register 304 is determined based on the system calls made by the OS 310 through the interface 302. These system calls either specifically identify the appropriate register 304 or are resolved by the firmware and/or software 303 based on the type of system call being made through the interface 302.

Once the processor 301 has selected the appropriate register 304 that is used by the processor 301 to log branch trace store data, the firmware and/or software 303 inspects the privilege level received from the OS 310 to determine which privilege flags/fields contained within the register 304 need to be modified (e.g., set or unset, as the case may be). Thus, the appropriate privilege flags/fields are modified in accordance with the desired privilege level within the register 304.

Next, once the second application 330 is executed, the firmware and/or software 303 inspects each instruction being processed and selectively logs branch trace store data that corresponds to instructions that are in a processor execution mode which conforms to set privilege flags/fields included with the register 304. Thus, if one or more privilege flags/fields are set which correspond to a user execution mode of the processor 301, then only branch trace store data being processed in this mode are logged to the buffer for the executing second application 330.

In this way, once the second application 330 terminates normally or abnormally, the first application 320 can gain access to the buffer through the OS 310 to inspect and analyze the logged branch trace store data. This is assuming, the privilege level originally requested comports access authority of an operator. As one of ordinary skill in the art appreciates, this permits a software developer of the second application 330 to gain access to the branch trace store data to detect error conditions (e.g., failures or unexpected results) or in an attempt to improve performance of the second application 330. The software developer uses the first application 320 (e.g. debugger application) to analyze the branch trace store data.

In various embodiments of the branch trace store data system 300 of FIG. 3, the interface 302 is a collection of system calls that are available to the OS 310 in order to permit the firmware and/or software 303 of the processor 301 to selectively log branch trace store data based on provided privilege levels and any needed buffer information. In some embodiments, these added system calls can be added as upgrades to existing legacy processor architectures and OS implementations. This permits backward compatibility with minimal effort on the part of processor and OS manufacturers and quickly provides the benefits of various embodiments of the present invention.

Some of the OS 310 provided system calls embodied in the interface 302 can include, but are not limited to, calls that provide a privilege level, provide an address to a log buffer, provide the identity of the second application 330, and provide configuration data associated with the log buffer. Of course other system calls can be added to the interface 302 in other embodiments without departing from the present invention. Moreover, in some embodiments, only a privilege level system call can comprise the interface 302, since in some embodiments the processor 301 can reserve and manage the buffer and the OS 310 can be configured to know its location.

One of ordinary skill in the art now understands, how a flexible machine or processor architecture is implemented with various embodiments of the present invention to achieve qualified branch trace store data logging. These embodiments do not unduly tax the resources of the processor 301 or the processing efficiency of the OS 310, and only a single buffer needs to be maintained for a second application 330 in order to selectively provide and log branch trace selection data based on a configurable execution mode of the processor 301. This is achieved by selectively logging branch trace store data to a single buffer.

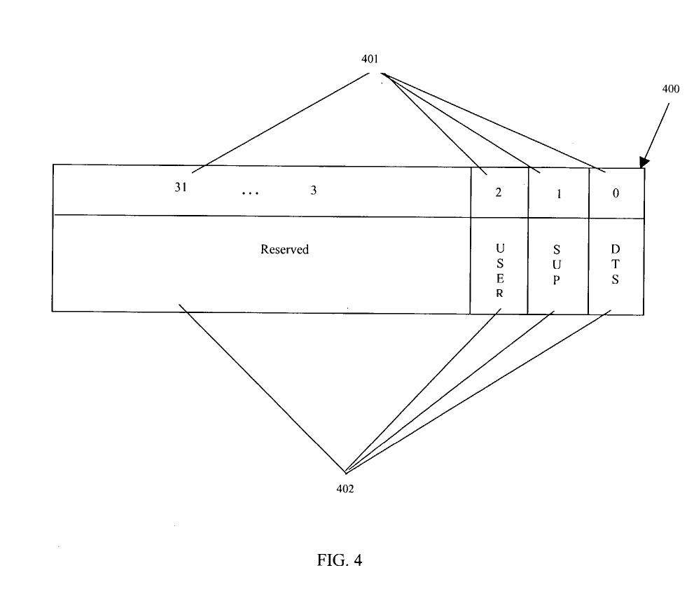

FIG. 4 illustrates a diagram of an example data structure 400 for selectively identifying branch trace store data, in accordance with one embodiment of the invention. FIG. 4 is presented for purposes of illustration only and is not intended to limit various embodiments of the present invention.

The data structure 400 represents a 32-bit word that is managed by an architecture of a processor or machine. The word is stored in memory or a register of the processor and used to identify and control branch trace store data logging. The word includes 32 bit fields 401. Each field 401 includes a binary bit value/flag 402 that is either set (e.g., 1) or unset (e.g., 0).

Field 0 401 is labeled “DTS” this bit represents debug trace store that when set enables logging of branch messages to a target buffer. Field 1 401 is labeled “SUP” this represents a supervisory execution mode of the processor that when set enables logging of branch trace store data for instructions associated with the supervisory execution mode. Field 2 401 is labeled “USER” this represents a user execution mode of the processor that when set enables logging of branch trace store data for instructions associated with the user execution mode. Fields 3-31 401 are reserved for future enhancements to processor architectures.

As previously presented, the data structure 400 of FIG. 4 can be used to selectively instruct the processor's firmware and/or software to log branch store data to a buffer during execution of an application. This is achieved by enabling the DTS bit/flag field (e.g., field 0 402) by setting it and inspecting a privilege level request received from an OS. The privilege level instructs the processor's firmware and/or software to set either the USER bit/flag (e.g., field 1 402) and/or the SUP bit/flag field (e.g., field 2 402). Thus, during execution of an identified application each processed instruction is inspected to determine the execution mode and compared to the USER and/or SUP bits/flags (e.g., fields 1-2 402), and when appropriate branch trace store data is logged to an identified memory buffer.

Although only two execution modes are presented with FIG. 4, it is readily apparent that reserved bits/flags 3-31 402 can be used for a variety of other processor execution modes. Thus, various embodiments of the present invention can selectively log branch trace store data based with any identifiable processor execution mode. Moreover, with previous architectures bits/flags 1 and 2 may have been previously reserved, in these instances the various embodiments of the present invention can still be integrated with these older architectures. This can be achieved by assuming that if both the USER and SUP bits/flags (e.g., fields 1-2 402) are unset, then both user execution modes and supervisory execution modes are to be logged when the DTS bit/flag is set. This would be the way old architectures work and would create a consistent default condition that would be backwardly compatible with older architectures. The older architectures can then be upgraded with modified software to permit the usage and setting of the USER and/or SUP bits/flags (e.g., fields 1-2 402) so as to take advantage of various embodiments of the present invention.

Various embodiments of the present invention permit the selective logging of branch trace store data. This is achieved by using a single memory buffer and leverages existing techniques associated with processor architectures. Thus, the memory and processing efficiencies are not adversely affected when deploying the techniques presented herein. Additionally, user-debugging applications can now utilize branch trace store data to debug user execution mode applications. This is a benefit to software developers that heretofore have not had this capability due to a variety of efficiency and security concerns. User mode operators can now trace user applications for failures, unexpected results, and/or efficiency bottlenecks.

It is to be understood that the above description is intended to be illustrative, and not restrictive. Many other embodiments will be apparent to those of skill in the art upon reviewing the above description. The scope of embodiments of the invention should, therefore, be determined with reference to the appended claims, along with the full scope of equivalents to which such claims are entitled.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Description of the Embodiments, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject mater lies in less than all features of a single disclosed embodiment. Thus the following claims are hereby incorporated into the Description of the Embodiments, with each claim standing on its own as a separate exemplary embodiment.

What is claimed is:

1. A method to provide privileged-based qualifications for branch trace store data, comprising:
receiving a privilege level associated with recording branch trace store data; and
using the privilege level to set one or more privilege flags associated with the privilege level, wherein the set one or more privilege flags are used to selectively log branch trace store data.

2. The method of claim 1 further comprising receiving an address to a buffer where the branch trace store data is selectively logged.

3. The method of claim 2 further comprising selectively logging the branch trace store data to the buffer using the address, wherein the branch trace store data is associated with the execution of an application associated with the received privilege level.

4. The method of claim 1 wherein in receiving the privilege level, the privilege level is associated with at least one of a user application mode and a supervisory application mode.

5. The method of claim 1 wherein in using the privilege level, the one or more privilege flags are bits in a register of a processor.

6. The method of claim 1 wherein in receiving the privilege level, the privilege level is an identification of an execution mode associated with a processor.

7. The method of claim 6 wherein the method is performed by at least one of firmware instructions of a processor and software instructions.

8. An article having a machine accessible medium having associated instructions, wherein the instructions, when executed, result in a machine comprising at least one component performing:
receiving a privilege level from an application, wherein the privilege level identifies an execution mode of the machine for which branch trace store data is to be recorded;
modifying one or more privilege flags based on the received privilege level; and
logging selective branch trace store data to a buffer based on settings for the one or more privilege flags.

9. The article of claim 8 further comprising instructions for receiving an address for the buffer from an operation system operation prior to logging the selective branch trace store data.

10. The article of claim 8 further comprising instructions for receiving configuration data associated with the buffer.

11. The article of claim 10 wherein in receiving the configuration data, at least a portion of the configuration data identifies whether the selective branch trace data is to be logged circularly within the buffer or whether the buffer is to be offloaded to storage when the buffer becomes full with the selective branch trace data.

12. The article of claim 10 wherein in logging the selective branch trace data, the buffer is at least one of a volatile storage or a non volatile storage.

13. The article of claim 8 wherein in receiving the privilege level, the branch trace store data represents execution branches for the application when the application is executing.

14. The article of claim 8 wherein in modifying the one or more privilege flags, the one or more privilege flags include a first privilege flag representing a user application mode and a second privilege flag representing a supervisory application mode.

15. A branch trace store data logging system, comprising:
a processor having an interface that permits a first application to request that selective branch trace store data be logged to a buffer during execution of a second application; and
wherein the interface permits the first application to identify a privilege level associated with the selective branch store data, and the processor uses the privilege level to set one or more privilege flags that permit the processor to selectively log the selective branch store data to the buffer during execution of the second application.

16. The branch trace store data logging system of claim 15 wherein the first application uses the interface indirectly through an operating system.

17. The branch trace store data logging system of claim 15 wherein the first application is a debugger application used to analyze the selective branch trace store data logged in the buffer in order to trace the execution of the second application.

18. The branch trace store data logging system of claim of 15 wherein an operating system operation uses the interface to provide an address for the buffer after the operating system operation allocates memory for the buffer.

19. The branch trace store data logging system of claim 18 wherein the one or more privilege flags reside in a register of the processor.

20. The branch trace store data logging system of claim 18 wherein the interface comprises operations recognized by the processor and the operations include providing the privilege level, providing an address to the buffer, and identifying the second application.
